(19) United States
(12) Patent Application Publication
(10) Pub. No.: US 2025/0053022 A1
(43) Pub. Date: Feb. 13, 2025

(54) OPTICAL WAVEGUIDE DEVICE, DISPLAY APPARATUS AND DISPLAY DEVICE

(71) Applicant: Shenzhen Pencilvision Technology Co., Ltd., Shenzhen (CN)

(72) Inventor: Zhidong Chen, Shenzhen (CN)

(21) Appl. No.: 18/723,410

(22) PCT Filed: Oct. 21, 2022
(86) PCT No.: PCT/CN2022/126652

§ 371 Date: Jun. 21, 2024

(30) Foreign Application Priority Data
Dec. 24, 2021 (CN) 202111594430.7
Mar. 22, 2022 (CN) 202220635648.6

(51) Int. Cl. G02B 27/28; G03H 1/02

(52) U.S. Cl. CPC G02B 27/286; G03H 1/0252

(57) ABSTRACT

An optical waveguide device, a display apparatus, and a display device are disclosed. The optical waveguide device includes an optical waveguide dielectric body, a first polarized reflection layer, and an optical structure layer. The optical waveguide dielectric body includes a first surface and a second surface opposite to each other, the first polarized reflection layer is arranged on the first surface, and the optical structure layer is arranged on the second surface. The optical waveguide dielectric body is configured to propagate light, which includes a first polarized light. The first polarized reflection layer is configured to reflect the first polarized light and transmit a second polarized light. The optical structure layer is configured to convert the first polarized light incident at a preset angle into the second polarized light, reflect the second polarized light to the first polarized reflection layer, and reflect the first polarized light incident at another angle to the first polarized reflection layer. An exit region of the second polarized light is no longer limited to a region without a reflective film layer, thereby increasing a light exit range of the optical waveguide device.

### TECHNICAL FIELD

Embodiments of the present disclosure relate to the technical field of optical display, in particular to an optical waveguide device, a display apparatus, and a display device.

### BACKGROUND

An optical waveguide is a dielectric apparatus that guides light waves for propagation, and is also known as a dielectric optical waveguide. Due to its lightweight and thin advantages, the optical waveguide has become an important component of a near-eye display apparatus. However, most optical waveguide elements currently propagate light based on the principle of total reflection. A reflective film can be formed on the surface of an optical waveguide element, allowing light that does not meet the conditions for total reflection to continue propagating within the optical waveguide element through the reflective film. This prevents light from exiting the optical waveguide element and affecting the display effect. However, in this way, the light within the optical waveguide element can only exit in a region without the reflective film to form a display image. This significantly limits the light's exit range.

### SUMMARY

### Technical Problem

The present disclosure aims to provide an optical waveguide device, a display apparatus, and a display device, to increase a light exit range of the optical waveguide device.

### Technical Solution

To resolve the foregoing problems, embodiments of the present disclosure provide the following technical solutions.

According to a first aspect of the present disclosure, an optical waveguide device is disclosed. The optical waveguide device includes an optical waveguide dielectric body, a first polarized reflection layer, and an optical structure layer. The optical waveguide dielectric body comprises a first surface and a second surface opposite to each other. The first polarized reflection layer is arranged on the first surface. The optical structure layer is arranged on the second surface.

The optical waveguide dielectric body is configured to propagate light, which includes a first polarized light.

The first polarized reflection layer is configured to reflect the first polarized light and transmit a second polarized light, where the polarization direction of the second polarized light is perpendicular to that of the first polarized light;

The optical structure layer is configured to convert the first polarized light, incident at a preset angle, into the second polarized light, and to reflect the second polarized light back to the first polarized reflection layer, as well as to reflect the first polarized light, incident at other angles back to the first polarized reflection layer.

According to a second aspect of the present disclosure, a display apparatus is disclosed. The display apparatus includes a micro image source and the optical waveguide device as described above. The micro image source is configured to emit light, which is required for image display to the optical waveguide device, and the light includes the first polarized light.

According to a third aspect of the present disclosure, a display device is disclosed. The display device includes the display apparatus as described above.

### Beneficial Effects

Embodiments of the present disclosure provide an optical waveguide device, a display apparatus, and a display device. An optical structure layer can convert first polarized light incident at a preset angle into second polarized light and reflect the second polarized light to a first polarized reflection layer, while the first polarized reflection layer can transmit the second polarized light. Therefore, the second polarized light, which is converted from the first polarized light incident at the preset angle, can exit the optical waveguide device to form a display image.

The optical structure layer can reflect a first polarized light incident at other angles back to the first polarized reflection layer, and the first polarized reflection layer can transmit the first polarized light. Therefore, the first polarized light, incident at other angles, can be continuously reflected between the optical structure layer and the first polarized reflection layer, preventing the first polarized light incident at other angles from exiting the optical waveguide device and interfering with the image display.

It can be seen that in the embodiment of the present disclosure, all regions of the first polarized reflection layer can reflect the first polarized light incident at other angles and transmit the second polarized light converted from the first polarized light incident at the preset angle. Based on this, in the embodiments of the present disclosure, the exit region of the second polarized light is no longer limited to the region without the reflective film layer, thereby increasing a light exit range of the optical waveguide device, and thus further increasing image display range of the display apparatus and the display device that include the optical waveguide device.

### BRIEF DESCRIPTION OF THE DRAWINGS

To describe the technical solutions in embodiments of the present disclosure or the prior art more clearly, the following briefly describes the accompanying drawings required for describing the embodiments or the related art. It is clear that the accompanying drawings in the following descriptions show merely the embodiments of the present disclosure, and a person of ordinary skill in the art can still derive other drawings from the accompanying drawings without creative efforts.

FIG. 1 is a schematic diagram of a structure of an optical waveguide element for light propagation based on the principle of total reflection.

FIG. 2 is a schematic diagram of a structure of another optical waveguide element.

FIG. 3 is a schematic diagram of a cross-sectional structure of an optical waveguide device according to an embodiment of the present disclosure.

FIG. 4 is a schematic diagram of a three-dimensional structure of an optical waveguide device according to an embodiment of the present disclosure.

FIG. 5 is a schematic diagram of a cross-sectional structure of an optical waveguide device according to another embodiment of the present disclosure.

FIG. 6 is a schematic diagram of a cross-sectional structure of an optical waveguide device according to other embodiments of the present disclosure.

FIG. 7 is a schematic diagram of an exposure mode of a reflective holographic optical element according to an embodiment of the present disclosure.

FIG. 8 is a schematic diagram of a cross-sectional structure of an optical waveguide device according to another embodiment of the present disclosure.

FIG. 9 is a schematic diagram of a cross-sectional structure of an optical waveguide device according to another embodiment of the present disclosure.

FIG. 10 is a schematic diagram of a cross-sectional structure of an optical waveguide device according to another embodiment of the present disclosure.

FIG. 11 is a schematic diagram of a cross-sectional structure of an optical waveguide device according to another embodiment of the present disclosure.

FIG. 12 is a schematic diagram of a cross-sectional structure of an optical waveguide device according to another embodiment of the present disclosure.

FIG. 13 is a schematic diagram of a cross-sectional structure of an optical waveguide device according to another embodiment of the present disclosure.

FIG. 14 is a schematic diagram of a cross-sectional structure of an optical waveguide device according to another embodiment of the present disclosure.

FIG. 15 is a schematic diagram of a cross-sectional structure of an optical waveguide device according to another embodiment of the present disclosure.

FIG. 16 is a schematic diagram of a cross-sectional structure of an optical waveguide device according to another embodiment of the present disclosure.

FIG. 17 is a schematic diagram of a cross-sectional structure of a display apparatus according to an embodiment of the present disclosure.

FIG. 18 is a schematic diagram of a cross-sectional structure of a display apparatus according to an embodiment of the present disclosure.

FIG. 19 is a schematic diagram of a structure of an embodiment of an optical structure according to the present disclosure.

FIG. 20 is a schematic diagram of a structure of a light propagation path in FIG. 19.

FIG. 21 is a schematic diagram of a partial structure in FIG. 19.

### DETAILED DESCRIPTION

The technical solutions in the embodiments of this application are clearly and completely described below, with reference to the accompanying drawings. It is self-evident that the drawings described below are merely examples of the implementation of this application. For ordinary technicians in the field, it is possible to derive other drawings from the provided ones without the need for creative effort.

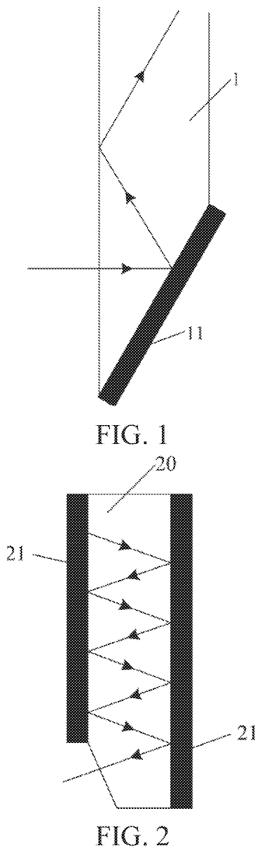

As described in the Background, most current optical waveguide elements are used for light propagation based on the principle of total reflection. As shown in FIG. 1, FIG. 1 is a schematic diagram of a structure of an optical waveguide element for light propagation based on the principle of total reflection. Incident light is reflected into the optical waveguide dielectric 1 by the reflective film 11. This ensures that the reflection angle of the incident light on the surface of the optical waveguide dielectric 1 is greater than the critical angle for total reflection. As a result, the light propagates within the optical waveguide dielectric 1 and exits after reaching a specific region to display an image. However, if the reflection angle of the light within the optical waveguide dielectric 1 is less than or equal to the critical angle for total reflection, the light exits from the optical waveguide dielectric 1. This exiting light can interfere with the light used for image display, thereby affecting the display effect.

As shown in FIG. 2, FIG. 2 is a schematic diagram of a structure of another optical waveguide element. A reflective film 21 can be formed on the surface of an optical waveguide dielectric 20. This allows light that does not meet the total reflection condition to continue propagating within the optical waveguide dielectric 20 through the reflection by the reflective film 21, thereby avoiding impact on the image display effect caused by light exiting from the optical waveguide dielectric 20. However, light can only propagate in the region with the reflective film 21 and exit in the region without the reflective film 21. In other words, light can only exit in the region without the reflective film 21 to form a display image. Consequently, the light's exit range is significantly limited.

Based on this, embodiments of the present disclosure provide an optical waveguide device, a display apparatus, and a display device. A first polarized reflection layer is arranged on a first surface of an optical waveguide dielectric body, and an optical structure layer is arranged on a second surface of the optical waveguide dielectric body. The first polarized reflection layer reflects first polarized light and transmits second polarized light. The optical structure layer converts first polarized light, incident at a preset angle, into the second polarized light. It also reflects the second polarized light back to the first polarized reflection layer and reflects first polarized light, incident at other angles, to the first polarized reflection layer. This design ensures that the exit region of the second polarized light is no longer limited to a region without a reflective film layer. As a result, it increases the light exit range of the optical waveguide device and, in turn, increases the image display ranges of the display apparatus and the display device that incorporate the optical waveguide device.

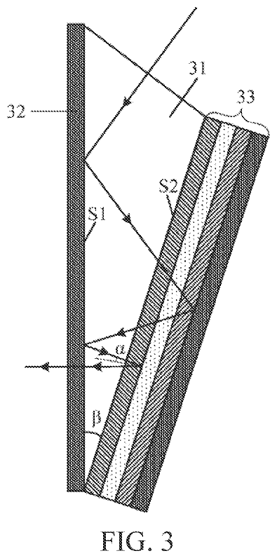

In an optional implementation of the content disclosed in the embodiments of the present disclosure, an embodiment of the present disclosure provides an optical waveguide device for realizing light transmission. As shown in FIG. 3, FIG. 3 is a schematic diagram of a cross-sectional structure of an optical waveguide device according to an embodiment of the present disclosure. The optical waveguide device includes an optical waveguide dielectric body 31, a first polarized reflection layer 32, and an optical structure layer 33.

The optical waveguide dielectric body 31 includes a first surface S1 and a second surface S2 opposite to each other. The first polarized reflection layer 32 is arranged on the first surface S1. The optical structure layer 33 is arranged on the second surface S2.

The optical waveguide dielectric body 31 is configured to propagate light, which includes a first polarized light. The first polarized reflection layer 32 is configured to reflect the first polarized light and transmit a second polarized light, where the polarization direction of the second polarized light is perpendicular to that of the first polarized light. For example, the first polarized light could be p-polarized light, and the second polarized light could be s-polarized light. Alternatively, the first polarized light could be s-polarized light, and the second polarized light could be p-polarized light.

The optical structure layer 33 is configured to convert the first polarized light incident at a preset angle, into the second polarized light, and to reflect the second polarized light back to the first polarized reflection layer 32, as well as to reflect the first polarized light incident at other angles back to the first polarized reflection layer 32.

As shown in FIG. 3, the first polarized light is incident on the first polarized reflection layer 32 from the optical waveguide dielectric body 31. It is then reflected to the optical structure layer 33 by the first polarized reflection layer 32. If an angle at which the first polarized light is incident on the optical structure layer 33 is the preset angle α, the optical structure layer 33 converts the first polarized light into the second polarized light. It then reflects the second polarized light back to the first polarized reflection layer 32, allowing the second polarized light to exit from the first polarized reflection layer 32 to the outside.

If the angle at which the first polarized light is incident on the optical structure layer 33 is other angles than the preset angle α, the optical structure layer 33 reflects the first polarized light back to the first polarized reflection layer 32. The first polarized reflection layer 32 then reflects the first polarized light again, so that the first polarized light incident at the other angles is continuously reflected between the first polarized reflection layer 32 and the optical structure layer 33. As a result, the first polarized light incident at other angles does not exit the optical waveguide device.

It should be noted that in the embodiments of the present disclosure, the preset angle α is defined as an angle range. If the angle at which the first polarized light is incident on the optical structure layer 33 falls within this angle range, it is considered the preset angle α. If the angle at which the first polarized light is incident on the optical structure layer 33 dose not fall within this angle range, it is considered other angles. Here, α=ω±t, where ω is a specific angle, and 0≤t≤15.

It should also be noted that, although in the embodiments of the present disclosure the first polarized light exiting from the optical waveguide dielectric body 31 first is incident on the first polarized reflection layer 32, the present disclosure is not limited. In some other embodiments, the first polarized light exiting from the optical waveguide dielectric body 31 can be alternatively first incident on the optical structure layer 33. Further details are not provided here.

In other words, in the embodiments of the present disclosure, the optical structure layer 33 converts the first polarized light, incident at the preset angle α, into the second polarized light and reflects it to the first polarized reflection layer 32. Concurrently, the first polarized reflection layer 32 can transmit the second polarized light. Therefore, the second polarized light, which is converted from the first polarized light incident at the preset angle α, can exit the optical waveguide device to form a display image.

The optical structure layer 33 can reflect the first polarized light incident at other angles to the first polarized reflection layer 32. Meanwhile, the first polarized reflection layer 32 can transmit the first polarized light. Therefore, the first polarized light incident at other angles can be continuously reflected between the optical structure layer 33 and the first polarized reflection layer 32, whereby the first polarized light entering at another angle will not exit from the optical waveguide device to avoid interference on image display.

It can be seen that all regions of the first polarized reflection layer 32 in the embodiments of the present disclosure can reflect the first polarized light incident at other angles and transmit the second polarized light obtained through conversion from the first polarized light incident at the preset angle α. Based on this, in the embodiments of the present disclosure, the exit region of the second polarized light is no longer limited to a region without a reflective film layer, thereby increasing the light exit range of the optical waveguide device.

In some embodiments of the present disclosure, as shown in FIG. 3, a first included angle β is formed between planes on which the first surface S1 and the second surface S2 are located, and the first included angle β is an acute angle, to change an Incidence angle of the first polarized light that is re-propagated to the first polarized reflection layer 32 or the optical structure layer 33.

In other words, because the first included angle β is formed between the planes on which the first surface S1 and the second surface S2 are located, this causes the angle at which the first polarized light, after being reflected by the first polarized reflection layer 32, is incident again on the optical structure layer 33 to be changed. Similarly, this causes the angle at which the first polarized light, after being reflected by the optical structure layer 33, is incident again on the first polarized reflection laver 32 to be changed.

After the first polarized light is reflected multiple times between the first polarized reflection layer 32 and the optical structure layer 33, if the angle at which it is incident on he optical structure layer 33 is changed to the preset angle α, the first polarized light is converted into the second polarized light by the optical structure layer 33. This is then reflected to the first polarized reflection layer 32 and transmitted to the outside by the first polarized reflection layer 32. Consequently, this further improves the utilization of the first polarized light, increases the brightness of the display image, and enhances the display effect.

It should be noted that in the embodiments of the present disclosure, the first included angle β, formed between the first surface S1 and the second surface S2, is not limited. In some other embodiments, the first surface S1 and the second surface S2 can be parallel to each other. In some other embodiments, the first included angle β can be greater than or equal to 90 degrees. By adjusting the angle of incidence of the first polarized light on the optical waveguide dielectric body 31, the first polarized light can be incident on the optical structure layer 33 at the preset angle α and is converted into the second polarized light. The resulting second polarized light is then transmitted to the outside through the first polarized reflection layer 32.

Such a design ensures that the first polarized light incident on the optical structure layer 33 at other angles is continuously reflected between the first polarized reflection layer 32 and the optical structure layer 33.

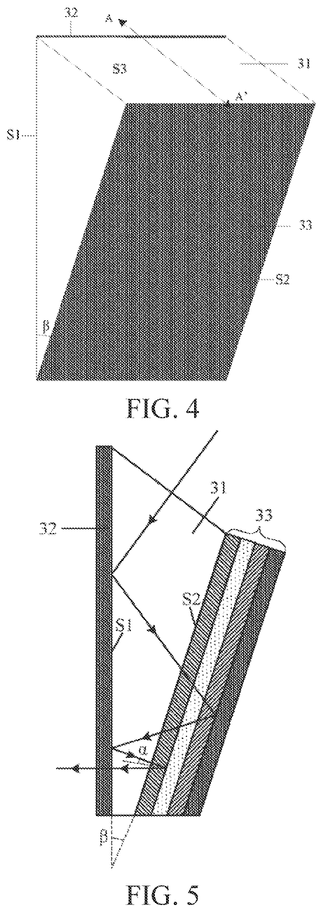

In some embodiments of the present disclosure, as shown in FIG. 4, FIG. 4 is a schematic diagram of a three-dimensional structure of an optical waveguide device according to an embodiment of the present disclosure. FIG. 3 is a schematic diagram of a cross-sectional structure of the optical waveguide device shown in FIG. 4 along a cutting line AA′. The shape of the optical waveguide dielectric body 31 is a triangular prism. The first polarized reflection layer 32 is arranged on the first surface S1 of the triangular prism. The optical structure layer 33 is arranged on the second surface S2 of the triangular prism. The included angle between the first surface S1 and the second surface S2 is the first included angle β.

In some embodiments of the present disclosure, light, including the first polarized light, can be incident on the optical waveguide dielectric body 31 from the outside through a surface S3. The surface S3 intersects the first surface S1 and the second surface S2. It is clear that in some other embodiments, based on a practical application of the optical waveguide device, light can be alternatively incident on the optical waveguide dielectric body 31 from either of two surfaces other than the first surface S1, the second surface S2, and the surface S3. Details are not described herein again.

The optical waveguide dielectric body 31 in the embodiments of the present disclosure can take various shapes and is not limited to the triangular prism. It can also be a quadrangular prism, a pentagonal prism, or another irregular shape.

As shown in FIG. 5, FIG. 5 is a schematic diagram of a cross-sectional structure of an optical waveguide device according to another embodiment of the present disclosure. The shape of the optical waveguide dielectric body 31 is a quadrangular prism. The first polarized reflection layer 32 and the optical structure layer 33 are respectively arranged on the first surface S1 and the second surface S2, where an included angle between extension lines of the first surface S1 and the second surface S2 is the first included angle β.

It should be noted that although the first surface S1 and the second surface S2 are both planar in FIG. 3 to FIG. 5, the present disclosure is not limited thereto. In some other embodiments, the first surface S1 and the second surface S2 can alternatively be cambered or curved provided that the first surface S1 can reflect light to the second surface S2 and the second surface S2 can reflect light to the first surface S1. Details are not described herein again.

In some embodiments of the present disclosure, the optical structure layer 33 is further configured to transmit the second polarized light from external light to the first polarized reflection layer 32, so that the second polarized light from the external light is transmitted through the optical waveguide device. The external light is ambient light in an environment in which the optical waveguide device is located. In other words, a display apparatus using the optical waveguide device can transmit background light, and can realize a display mode integrating virtuality and reality.

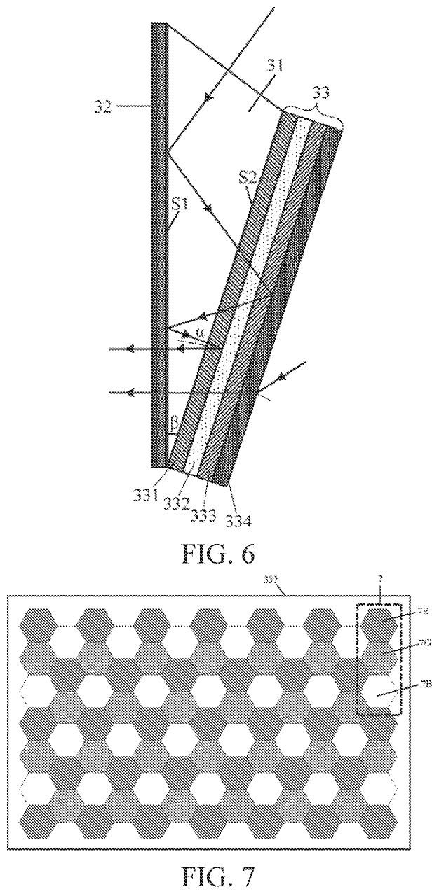

Based on the foregoing embodiments, in some embodiments of the present disclosure, as shown in FIG. 6, FIG. 6 is a schematic diagram of a cross-sectional structure of an optical waveguide device according to other embodiments of the present disclosure. The optical structure layer includes a first phase retarder layer 331, a reflective holographic optical element 332, a second phase retarder layer 333, and a second polarized reflection layer 334.

The first phase retarder layer 331, the reflective holographic optical element 332, the second phase retarder layer 333, and the second polarized reflection layer 334 are sequentially arranged on the second surface S2. The first phase retarder layer 331 and the second phase retarder layer 333 are both configured to delay the phase of the light, the polarization state of polarized light remains unchanged after passing through the first phase retarder layer 331 and the second phase retarder layer 333. The first polarized light is converted into the second polarized light by the first phase retarder layer 331 or the second phase retarder layer 333 after an even number of passes. The second polarized light is converted into the first polarized light after passing through the first phase retarder layer 331 or the second phase retarder layer 333 for an even number of times. The reflective holographic optical element 332 is configured to reflect light incident at the preset angle α and to transmit light incident at other angles. The second polarized reflection layer 334 is configured to reflect the first polarized light and transmit the second polarized light.

As shown in FIG. 6, the first polarized light incident on the optical structure layer 33 passes through the first phase retarder layer 331 and is then incident on the reflective holographic optical element 332. If the first polarized light is incident on the reflective holographic optical element 332 at the preset angle α, the reflective holographic optical element 332 reflects the first polarized light, so that the first polarized light passes through the first phase retarder layer 331 again. The first polarized light passes through the first phase retarder layer 331 twice. Therefore, the first polarized light is converted into the second polarized light, which exits to the first polarized reflection layer 32 and then is transmitted to the outside by the first polarized reflection layer 32.

If the first polarized light is incident on the reflective holographic optical element 332 at other angles, the reflective holographic optical element 332 transmits the first polarized light, so that the first polarized light passes through the second phase retarder layer 333 and is then incident on the second polarized reflection layer 334. The polarization status of the first polarized light, after passing through the first phase retarder layer 331 and the second phase retarder layer 333, remains unchanged, that is, the polarization status is still the first polarized light. Therefore, the second polarized reflection layer 334 reflects the first polarized light, so that the first polarized light passes through the second phase retarder layer 333 and is incident on the reflective holographic optical element 332. After being transmitted by the reflective holographic optical element 332, the first polarized light passes through the first phase retarder layer 331. The polarization status of the first polarized light, after passing through the first phase retarder layer 331 and the second phase retarder layer 333 again, remains unchanged. Therefore, the first polarized light exits to the first polarized reflection layer 32 from the first phase retarder layer 331.

The second polarized reflection layer 334 reflects the first polarized light and transmits the second polarized light. Therefore, the second polarized light in the external light is incident on the second phase retarder layer 333 after being transmitted through the second polarized reflection layer 334, and is incident on the reflective holographic optical element 332 after passing through the second phase retarder layer 333. The second polarized light incident on the reflective holographic optical element 332 at the preset angle α is reflected back to the outside, and the second polarized light incident on the reflective holographic optical element 332 at other angles is transmitted to the first phase retarder layer 331. The polarization status of the second polarized light, after passing through the first phase retarder layer 331 and the second phase retarder layer 333, remains unchanged. Therefore, the second polarized light is transmitted to the outside by the first polarized reflection layer 32. Based on this, the external light can penetrate the optical waveguide device from right to left, thereby realizing a display mode integrating virtuality and reality.

In some embodiments of the present disclosure, the first phase retarder layer 331 includes a ¼ wavelength retardation layer. The ¼ wavelength retardation layer can be a ¼ wave plate. The second phase retarder layer 333 includes a ¾ wavelength retardation layer. The ¾ wavelength retardation layer can be a ¾ wave plate.

The phase of the first polarized light is retarded by ¼ wavelength after passing through the first phase retarder layer 331 and by ¾ wavelength after passing through the second phase retarder layer 333. In other words, the phase difference of the first polarized light, after sequentially passing through the first phase retarder layer 331 and the second phase retarder layer 333, totals a full wavelength, ensuring that the polarization status of the first polarized light remains unchanged. After passing through the first phase retarder layer 331 or the second phase retarder layer 333 an even number of times, the first polarized light has a phase difference of ½ of a wavelength. Therefore, the first polarized light is converted into the second polarized light.

The present disclosure is not limited to the specific configurations. In other embodiments, the first phase retarder layer 331 includes a ¼ wavelength retardation layer. The second phase retarder layer 333 also includes a ¼ wavelength retardation layer. However, the second phase retarder layer 333 has an opposite retardation direction compares to the first phase retarder layer 331. The phase of the first polarized light is retarded by ¼ wavelength after passing through the first phase retarder layer 331 and advanced by ¼ wavelength after passing through the second phase retarder layer 333, so that the phase difference of the first polarized light after passing through the first phase retarder layer 331 and the second phase retarder layer 333 is 0, and the polarization status of the first polarized light remains unchanged.

It should be noted that in some embodiments of the present disclosure, the first polarized light and the second polarized light are both linear polarized light. In addition, the first phase retarder layer 331 and the second phase retarder layer 333 are configured to convert the linear polarized light into circular polarized light or convert the circular polarized light into the linear polarized light. For example, the first polarized light is converted into the circular polarized light after passing through the first phase retarder layer 331, and the circular polarized light is converted into the linear polarized light again after passing through the first phase retarder layer 331 or the second phase retarder layer 333.

In some embodiments of the present disclosure, the reflective holographic optical element 332 is a diffractive optical film layer made based on the principle of holography. A relationship among entrance, reflection, and transmission of light can be designed by designing a diffraction pattern of the reflective holographic optical element 332, so that the reflective holographic optical element 332 has angle selectivity. To be specific, the reflective holographic optical element 332 can reflect light at the preset angle α and transmit light at another angle.

It should be noted that when the reflective holographic optical element 332 is manufactured, it is typically exposed to object light and reference light emitted from a point light source. In some embodiments of the present disclosure, the reflective holographic optical element 332 can be integrally exposed to light with RGB three-color wavelengths. This enables the reflective holographic optical element 332 only reflects red, green, and blue light from incident light at the preset angle α. The red, green and blue light reflected by the reflective holographic optical element 332 can be mixed to form various gray scales, which are required for displaying an image.

It is clear that the present disclosure is not limited thereto. In other embodiments, as shown in FIG. 7, FIG. 7 is a schematic diagram of an exposure mode of a reflective holographic optical element according to an embodiment of the present disclosure. The reflective holographic optical element 332 includes a plurality of multiple reflecting regions 7 arranged in an array. Each reflecting region 7 includes a first reflecting sub-region 7R, a second reflecting sub-region 7G, and a third reflecting sub-region 7B arranged adjacently, and the plurality of first reflecting sub-regions 7R, a plurality of second reflecting sub-regions 7G, or a plurality of third reflecting sub-regions 7B are also arranged in an array. In addition, the first reflecting sub-region 7R is configured to reflect the red light from the light, the second reflecting sub-region 7G is configured to reflect the green light from the light, and the third reflecting sub-region 7B is configured to reflect the blue light from the light.

It should be noted that in FIG. 7, only an example in which the reflecting sub-regions are hexagonal is used for description, but the present disclosure is not limited thereto. In other embodiments, the reflecting sub-regions can be triangular, rectangular, circular, or the like. The size of each reflecting sub-region can be 0.5 mm to 0.6 mm.

It should also be noted that in other embodiments, the optical structure layer 33 can not transmit the external light to the first polarized reflection layer 32. In other words, a display apparatus using the optical waveguide device cannot transmit background light, and the display integrating virtuality and reality cannot be realized. In some optional examples, the second polarized reflection layer 334 can be replaced with a full-wavelength reflection layer, ensuring that all ambient light is reflected by the full-wavelength reflection layer and cannot enter the optical waveguide device.

Furthermore, in other embodiments, the optical waveguide device can further include a light transmission control layer. The light transmission control layer is configured to control whether the external light is transmitted through the optical waveguide device. The light transmission control layer can include a liquid crystal light valve, an electronic switch, a liquid crystal atomization film, or the like.

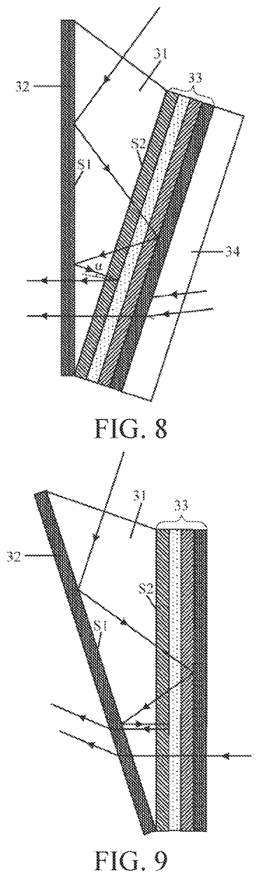

In some embodiments of the present disclosure, as shown in FIG. 8, FIG. 8 is a schematic diagram of a cross-sectional structure of an optical waveguide device according to another embodiment of the present disclosure. The light transmission control layer 34 is arranged on the side of the optical structure layer 33 that is away from the optical waveguide dielectric body 31.

In a first state, the light transmission control layer 34 transmits the external light, to allow the external light to be incident on the optical structure layer 33. In the second state, the light transmission control layer 34 blocks the external light, preventing the external light from being incident on the optical structure layer 33.

For example, when the light transmission control layer 34 is the liquid crystal light valve, it is turned on in the first state, allowing light to pass through the liquid crystal light valve, and is turned off in the second state, preventing light from passing through the liquid crystal light valve.

It should be noted that in the embodiments of the present disclosure, the exit direction of the second polarized light can be adjusted by adjusting the direction or angle of the light incident on the optical waveguide dielectric body 31, and/or by adjusting the direction or angle of the optical waveguide device, so that the optical waveguide device can meet the requirements for the light exit direction or angle in practical applications.

As shown in FIG. 8, the direction of the optical waveguide device can be such that the first surface S1 is perpendicular to the horizontal plane, allowing the second polarized light to exit in a direction perpendicular to the first surface S1. That is, the exit direction of the second polarized light exiting from the first polarized reflection layer 32 is perpendicular to the first surface S1.

In other embodiments, as shown in FIG. 9, FIG. 9 is a schematic diagram of a cross-sectional structure of an optical waveguide device according to another embodiment of the present disclosure. The direction of the optical waveguide device can also be such that the second surface S2 is perpendicular to the horizontal plane, causing the second polarized light to exit in a direction perpendicular to the second surface S2. That is, the exit direction of the second polarized light exiting from the first polarized reflection layer 32 is perpendicular to the second surface S2.

The angle between the first surface S1 and the second surface S2 is an acute angle in some embodiments. Therefore, after the second polarized light exits through the first polarized reflection layer 32, the direction is shifted. Based on this, in some embodiments of the present disclosure, the optical waveguide device further includes an optical correction body. The optical correction body is configured to correct an exit direction of at least part of the second polarized light that exits from the first polarized reflection layer 32.

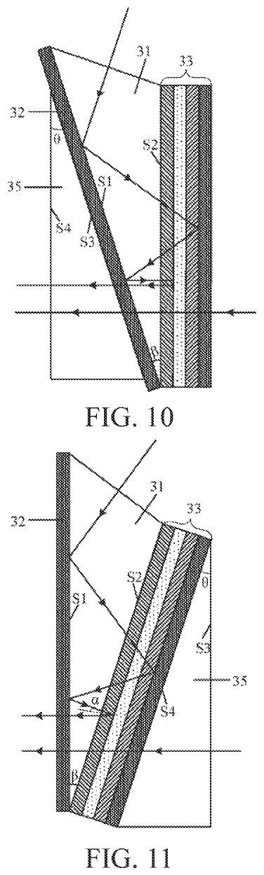

As shown in FIG. 10, FIG. 10 is a schematic diagram of a cross-sectional structure of an optical waveguide device according to another embodiment of the present disclosure. The optical correction body 35 is arranged on the side of the first polarized reflection layer 32, which is away from the optical waveguide dielectric body 31, to correct the exit direction of all the second polarized light exiting from the first polarized reflection layer 32, so that the exit direction of the second polarized light is a direction as required.

Alternatively, as shown in FIG. 11, FIG. 11 is a schematic diagram of a cross-sectional structure of an optical waveguide device according to another embodiment of the present disclosure. The optical correction body 35 is arranged on the side of the optical structure layer 33, which is away from the optical waveguide dielectric body 31, to correct the exit direction of a portion of the second polarized light exiting from the first polarized reflection layer 32. This portion of the second polarized light is the second polarized light that has transmitted through the optical waveguide device from the external light.

In some embodiments of the present disclosure, the optical correction body 35 and the optical waveguide dielectric body 31 have a same refractive index. In addition, as shown in FIG. 10 or 11, the optical correction body 35 includes a third surface S3 and a fourth surface S4. A second included angle θ is formed between the planes on which the third surface S3 and the fourth surface S4 are located. The second included angle θ is equal to the first included angle s. In addition, the third surface S3 is parallel to the first surface S1, and the fourth surface S4 is parallel to the second surface S2, so that the propagation direction of the second polarized light in the external environment substantially remains unchanged after penetrating the optical waveguide device. It should be noted that because the first polarized reflection layer 32 and the optical structure layer 33 are thin, a directional deviation caused by refraction of light in the first polarized reflection layer and the optical structure layer can be ignored.

Based on any of the foregoing embodiments, in some embodiments of the present disclosure, the optical waveguide device further includes a polarization absorption layer. The polarization absorption layer is configured to absorb the first polarized light and transmit the second polarized light. The polarization absorption layer is arranged on the side of the first polarized reflection layer 32, which is away from the optical waveguide dielectric body 31, and/or, the polarization absorption layer is arranged on a side of the optical structure layer 33, also away from the optical waveguide dielectric body 31.

It should be noted that the polarity direction of the polarization absorption layer is parallel to the polarity direction of the first polarized reflection layer 32 and the second polarized reflection layer 334. Therefore, after the first polarized light is absorbed by the polarization absorption layer, the backward reflection of light is eliminated, thereby avoiding interference on the exiting second polarized light caused by reflection of the first polarized light in the external light by the first polarized reflection layer 32 or the second polarized reflection layer 334. The polarization absorption layer transmits the second polarized light. Therefore, the polarization absorption layer does not affect the exit and transmission of the second polarized light by the optical waveguide device.

Furthermore, the structure of the optical waveguide device in the embodiments of the present disclosure can effectively suppress interface reflected light. The interface reflected light can also be referred to as zero-order light. Although each interface produces the interface reflected light, the interface reflected light from two film layers with refractive indices that are close to each other is very weak and difficult for the human eye to detect; therefore, it can be neglected. For example, the interface reflected light is light reflected at: the interface between the optical waveguide dielectric body 31 and the first phase retarder layer 331, between the first phase retarder layer 331 and the reflective holographic optical element 332, between the reflective holographic optical element 332 and the second phase retarder layer 333, and between the second phase retarder layer 333 and the second polarized reflection layer 334.

However, interface reflected light of an interface contacting with air is strong, and it is necessary to eliminate interference caused by the interface reflected light. For the interface of the second polarized reflection layer 334 contacting with air, the first polarized light exiting from the optical waveguide dielectric body 31 is still the first polarized light after passing through the first phase retarder layer 331, the reflective holographic optical element 332, and the second phase retarder layer 333, and arriving at the interface between the second polarized reflection layer 334 and the air. That is, the interface reflected light of the interface between the second polarized reflection layer 334 and the air is the first polarized light. After being reflected, the interface reflected light is still the first polarized light after passing through the second phase retarder layer 333, the reflective holographic optical element 332, and the first phase retarder layer 331 again, and the first polarized light is reflected by the first polarized reflection layer 32. That is, the interface reflected light is continuously reflected between the first polarized reflection layer 32 and the second polarized reflection layer 334, and does not exit to the outside, thereby avoiding interference on image display.

It should be noted that although the first polarized reflection layer 32 and the second polarized reflection layer 334 reflect the first polarized light, they have a certain reflectivity, and a small amount of the first polarized light is still transmitted through the first polarized reflection layer 32. In the embodiments of the present disclosure, the polarization absorption layer is arranged on the side of the first polarized reflection layer 32 that is away from the optical waveguide dielectric body 31, so that the polarization absorption layer absorbs a small amount of transmitted first polarized light, and the interface reflected light can be further suppressed. In addition, after the polarization absorption layer is arranged, the interface contacting with the air is the surface of the polarization absorption layer. Because the reflectivity of the polarization absorption layer to the first polarized light is low, the interface reflected light generated by the interface contacting with the air can be further reduced, thereby further suppressing the interface reflected light.

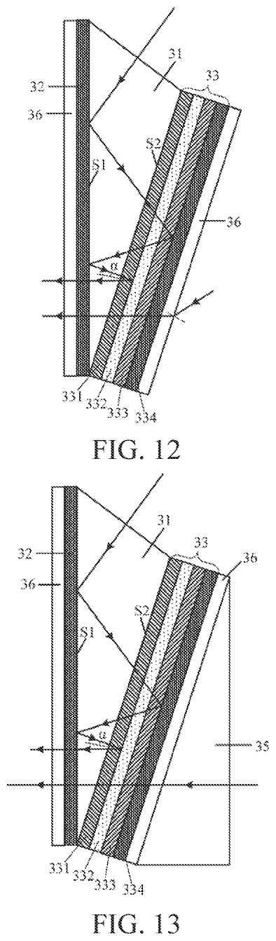

In some embodiments of the present disclosure, as shown in FIG. 12, FIG. 12 is a schematic diagram of a cross-sectional structure of an optical waveguide device according to another embodiment of the present disclosure. The polarization absorption layer 36 is arranged on the surface of the side of the first polarized reflection layer 32 that is away from the optical waveguide dielectric body 31, and the surface of the side of the optical structure layer 33 that is away from the optical waveguide dielectric body 31.

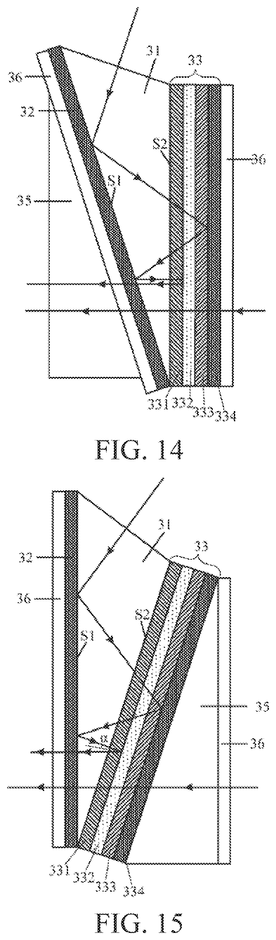

It is clear that the present disclosure is not limited thereto. As shown in FIG. 13, FIG. 13 is a schematic diagram of a cross-sectional structure of an optical waveguide device according to another embodiment of the present disclosure. The polarization absorption layer 36 can alternatively be arranged between the optical structure layer 33 and the optical correction body 35. Alternatively, as shown in FIG. 14, FIG. 14 is a schematic diagram of a cross-sectional structure of an optical waveguide device according to another embodiment of the present disclosure. The polarization absorption layer 36 can alternatively be arranged between the first polarized reflection layer 32 and the optical correction body 35.

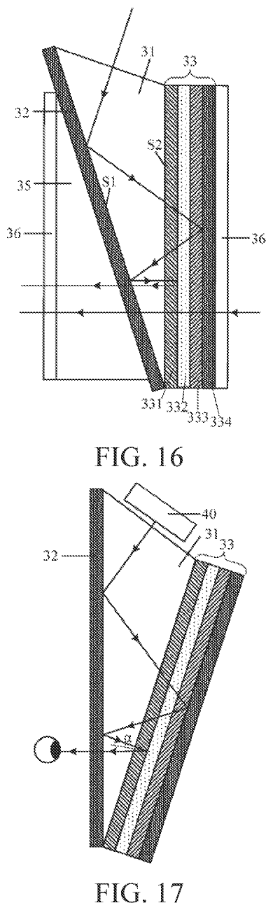

Alternatively, as shown in FIG. 15, FIG. 15 is a schematic diagram of a cross-sectional structure of an optical waveguide device according to another embodiment of the present disclosure. The optical correction body 35 is located between the optical structure layer 33 and the polarized absorption layer 36. In other words, the polarized absorption layer 36 can be arranged on the surface of the side of the optical correction body 35 that is away from the optical structure layer 33. Alternatively, as shown in FIG. 16, FIG. 16 is a schematic diagram of a cross-sectional structure of an optical waveguide device according to another embodiment of the present disclosure. The optical correction body 35 is located between the first polarized reflection layer 32 and the polarization absorption layer 36. In other words, the polarization absorption layer 36 can be arranged on the surface of a side of the optical correction body 35 that is away from the first polarized reflection layer 32.

In another optional implementation of the content disclosed in the embodiments of the present disclosure, an embodiment of the present disclosure further provides a display apparatus. The display apparatus includes the optical waveguide device provided in any of the foregoing embodiments and a micro image source. The micro image source is configured to emit light, which is required for image display to the optical waveguide device. The light includes the first polarized light.

In the embodiments of the present disclosure, by setting an angle of light exiting from the micro image source, the first polarized light required for image display is incident on the optical structure layer 33 at a preset angle. Light incident at another angle includes stray light such as ambient light.

As shown in FIG. 17, FIG. 17 is a schematic diagram of a cross-sectional structure of a display apparatus according to an embodiment of the present disclosure. Light required for image display exits from a micro image source 40 to the optical waveguide dielectric body 31 in the optical waveguide device. Then, first polarized light in the light is reflected to the optical structure layer 33 by the first polarized reflection layer 32. If an angle at which the first polarized light is incident on the optical structure layer 33 is a preset angle α, the optical structure layer 33 converts the first polarized light into second polarized light, and reflects the second polarized light to the first polarized reflection layer 32, so that the second polarized light exits from the first polarized reflection layer 32 to human eyes outside, and the human eyes can see a virtual image formed by the exiting second polarized light.

If the angle at which the first polarized light is incident on the optical structure layer 33 is other than the preset angle, the optical structure layer 33 reflects the first polarized light to the first polarized reflection layer 32. The first polarized reflection layer 32 will then reflect the first polarized light again, causing the first polarized light incident at other angles to be continuously reflected between the first polarized reflection layer 32 and the optical structure layer 33. This prevents the first polarized light incident at other angles from exiting the optical waveguide device, thus avoiding interference with image display.

It should be noted that in some embodiments of the present disclosure, the reflective holographic optical element in the optical structure layer 33 has a refractive effect and can enlarge an image. Therefore, the human eyes can see the enlarged image, thereby improving a viewing effect.

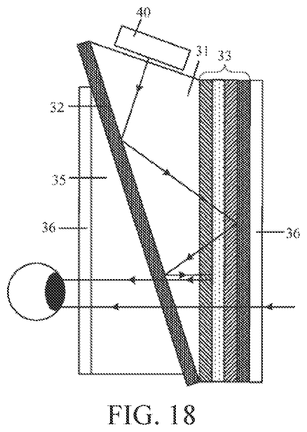

In some embodiments of the present disclosure, as shown in FIG. 18, FIG. 18 is a schematic diagram of a cross-sectional structure of a display apparatus according to another embodiment of the present disclosure. The optical waveguide device can transmit the second polarized light in the external light. Therefore, the human eyes can not only see a virtual image formed by the second polarized light, but also see second polarized light reflected by a real object. In other words, the real object can be seen through the display apparatus, and therefore, an integrated virtual-real image can be seen.

Based on this, the display apparatus in the embodiments of the present disclosure can be an augmented reality (AR) display apparatus, a virtual reality (VR) display apparatus, or the like. In addition, the display apparatus in the embodiments of the present disclosure can alternatively be a near-eye display apparatus.

In the embodiments of the present disclosure, the micro image source includes a laser image source, an LED image source, an OLED image source, or a micro-LED image source. The micro image source can be a laser image source. An image displayed by the laser image source is a laser light source image, including a laser-illuminated LCD image or a projected real image projected on a diffusion film by a laser-illuminated micro projector.

The micro image source can be a self-luminous micro image source. An image displayed by the self-luminous micro image source includes an image displayed by an OLED micro display or a micro display image displayed by a micro-LED. A narrow-band filter can be added between the micro image source and the optical waveguide device to filter light exiting from the micro image source to the optical waveguide device, thereby improving the display effect.

The type of micro image source can be an incoherent micro image source. An image displayed by the incoherent micro image source includes an LED-illuminated LCD image, an OLED micro display without a narrow-band filter, or a micro-LED display image.

In another optional implementation of the content disclosed in the embodiments of the present disclosure, an embodiment of the present disclosure further provides a display device. The display device includes the display apparatus as provided in any of the foregoing embodiments. The display device according to the embodiments of the present disclosure includes but is not limited to smart phones, pads, smart televisions, near-eye display devices such as VR glasses or AR glasses, and the like.

A head mounted display is an electronic product that can provide immersive experience. The display principle of the head mounted display includes an augmented reality technology, referred to as an AR display technology for short. The display principle of the head mounted display further includes a virtual reality technology, referred to as a VR display technology for short. The AR display is used for superimposing internal light and external light together, thereby adding virtual images to external real pictures. The VR display is used for displaying virtual pictures simulated by computers.

Currently, a single image source is provided in the head mounted display, and the single image source propagates in a waveguide body. When light propagates distally, it is difficult for the light to exit at a distal end of the waveguide body. As a result, a displayed image has a small picture size, the field of view of an image visible for a user is small, and the field of view of the user is limited, which is not conducive to the immersive experience of the user.

Based on this, it is necessary to provide an optical structure and a near-eye display device, which can improve the picture size of the displayed image, improve the field of view of the user and improve the immersive experience of the user, aiming at the problem that the current head mounted display has a small picture size of the displayed image, which leads to the limited field of view of the user and is not conducive to the immersive experience of the user.

To achieve the foregoing object, the present disclosure further provides an optical structure. The optical structure includes: a waveguide body, an image source group, a first polarized reflective film, and a polarized conversion assembly.

The waveguide body has a first surface and a second surface opposite to each other. The waveguide body further has a first light-incident end face and a second light-incident end face opposite to each other. The first light-incident end face is located between the first surface and the second surface of the waveguide body. The second light-incident end face is located between the first surface and the second surface of the waveguide body.

The image source group includes a first image source and a second image source. The first image source is arranged on the first light-incident end face. The second image source is arranged on the second light-incident end face.

The first polarized reflective film is arranged on the second surface of the waveguide body.

The polarized conversion assembly is arranged on the first surface of the waveguide body. The polarized conversion assembly is configured to emit light from the first image source and the second image source towards the second surface of the waveguide body.

In one embodiment, the waveguide body includes a first waveguide portion and a second waveguide portion. The first waveguide portion and the second waveguide portion are butted. The first light-incident end face is located at the end of the first waveguide portion that is away from the second waveguide body. The second light-incident end face is located at the end of the second waveguide portion that is away from the first waveguide portion.

In one embodiment, the first waveguide portion and the second waveguide portion are adhered and spliced.

Alternatively, the first waveguide portion and the second waveguide portion are integrally formed.

In one embodiment, the first waveguide portion includes a first sub-surface, and the second waveguide portion includes a second sub-surface. The first sub-surface and the second sub-surface form the second surface. An included angle is formed between the first sub-surface and the second sub-surface. The included angle is an obtuse angle.

In one embodiment, an included angle between the first light-incident end face and the first sub-surface is an acute angle, and an included angle between the second light-incident end face and the second sub-surface is an acute angle.

In one embodiment, the optical structure further includes a correction compensator for correcting a phase difference. The correction compensator is arranged on the second surface of the waveguide body.

In one embodiment, the polarized conversion assembly includes a first phase retarder, a holographic reflective film, a second phase retarder, and a second polarized reflective film. The first phase retarder, the holographic reflective film, the second phase retarder, and the second polarized reflective film are sequentially arranged away from the waveguide body.

Alternatively, the polarized conversion assembly includes a first phase retarder, a holographic reflective film, a second phase retarder, and a polarizer. The first phase retarder, the holographic reflective film and the polarizer are sequentially arranged away from the waveguide body.

In one embodiment, the optical structure further includes an anti-reflection polarizing film. The anti-reflection polarizing film is arranged on the side of the first polarized reflective film that is away from the waveguide body.

In one embodiment, either of the first image source and the second image source is any one of a laser image source, an LED image source, an OLED image source, or a micro-LED image source.

Furthermore, to achieve the foregoing object, the present disclosure further provides a near-eye display device. The near-eye display device includes a housing and an optical structure as described above. The optical structure is arranged in the housing.

In the technical solution, compared with the existing single image source, image sources arranged at both ends of the waveguide body respectively can enlarge the source of image light and increase the angle of emitting light. In the waveguide body, a distal end of one image source is a proximal end of the other image source. Therefore, the arrangement of two image sources can avoid the situation that there is no light exiting from the distal end of a single image source, thereby improving the picture size of the whole displayed image, increasing the field of view of the user and improving the immersive experience of the user. To ensure that light emitted by the image source group can be accurately directed to the user, the first polarized reflective film has a transmission direction. When the polarization direction of light is the same as the transmission direction of the first polarized reflective film, the light is transmitted through the first polarized reflective film. When the directions are different, the light is reflected by the first polarized reflective film. In addition, through the action of the polarized conversion assembly, the light reflected by the first polarized reflective film is directed back towards the second surface of the waveguide body until the polarization status of the light matches the transmission direction of the first polarized reflective film.

The following clearly and completely describes the technical solutions for the optical structure and the near-eye display device, with reference to the accompanying drawings, in the embodiments of the present disclosure. It is obvious that the described embodiments are some of the embodiments of the present disclosure rather than all of the embodiments. All other embodiments obtained by a person of ordinary skill in the art based on the embodiments in the present disclosure without involving creative efforts fall within the scope of protection of the present disclosure.

It should be noted that in the embodiments of the present disclosure, all directivity indications (such as up, down, left, right, front, and back) are only used to explain the relative positional relationship, movement situation and the like among the components under a specific posture (as shown in the figures). If the specific posture changes, the directivity indications change accordingly.

In addition, the descriptions in the present disclosure relating to “first”, “second”, and the like are for descriptive purposes only and cannot be construed as indicating or implying their relative importance or implying the number of technical features indicated. Therefore, features defined as “first” or “second” can explicitly or implicitly include at least one of the features. In the descriptions of the present disclosure, “a plurality of” means at least two, for example, two, three and the like, unless specifically and specifically limited otherwise.

In the present disclosure, the terms “connected”, “fixed”, and similar terms are broadly interpreted unless expressly specified and limited. For example, “fixed” can be a fixed connection, a detachable connection, or an integrated connection, can be a mechanical connection or an electrical connection, can be a direct connection or indirect connection through an intermediate medium, or can be an internal connection between two elements or an interactive relationship between two elements, unless otherwise expressly defined. The specific meanings of the foregoing terms in the present disclosure can be understood by a person of ordinary skill in the art on a case-by-case basis.

In addition, the technical solutions among the various embodiments of the present disclosure can be combined with each other, provided that the technical solutions can be realized by a person of ordinary skill in the art. When the combination of the technical solutions is contradictory or cannot be realized, it should be considered that the combination of the technical solutions does not exist and is not within the scope of protection claimed by the present disclosure.

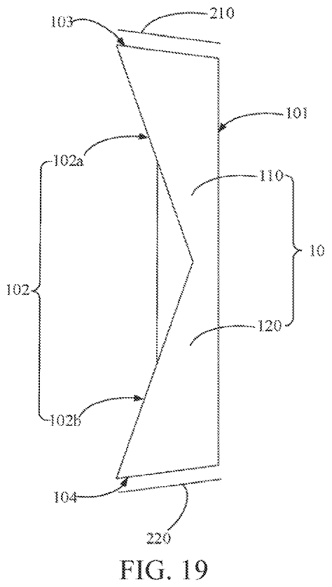

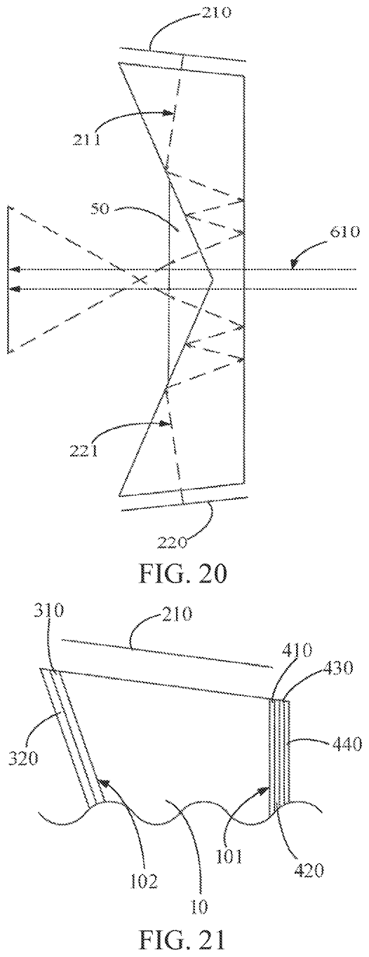

Referring to FIG. 19 to FIG. 21, this embodiment provides an optical structure. The optical structure includes a waveguide body 10, an image source group, a first polarized reflective film 310, and a polarized conversion assembly. The image source group is arranged near the waveguide body 10, and can be spaced apart from the waveguide body 10 by a specific distance, or can be in contact with the surface of the waveguide body 10. The first polarized reflective film 310 and the polarized conversion assembly are arranged on two opposite surfaces of the waveguide body 10 respectively. The first polarized reflective film 310 and the polarized conversion assembly can be independent optical devices. Alternatively they can be a film layer structure attached to the waveguide body 10.

The waveguide body 10 has a first surface 101 and a second surface 102 opposite to each other. The waveguide body 10 further has a first light-incident end face 103 and a second light-incident end face 104 opposite to each other. The first light-incident end face 103 is located between the first surface 101 and the second surface 102 of the waveguide body 10. The second light-incident end face 104 is located between the first surface 101 and the second surface 102 of the waveguide body 10. The first surface 101 faces an external environment, and the second surface 102 faces a user. The first surface 101 is also a flat surface.

The image source group includes a first image source 210 and a second image source 220. The first image source 210 is arranged on the first light-incident end face 103. The second image source 220 is arranged on the second light-incident end face 104. The first polarized reflective film 310 is arranged on the second surface 102 of the waveguide body 10.

The polarized conversion assembly is arranged on the first surface 101 of the waveguide body 10. The polarized conversion assembly is configured to emit light from the first image source 210 and the second image source 220 to the second surface 102 of the waveguide body 10. The optical structure can be applied to an AR display technology and a VR display technology. When the optical structure is applied to the AR display technology, light from the external environment is required to be incident on the second surface 102. For this purpose, the polarized conversion assembly can also transmit light from the outside to the waveguide body 10. The light emitted by the image source group and the light from the external environment are superimposed together.

In the technical solutions of this embodiment, image sources arranged at both ends of the waveguide body 10 can enlarge the image light source and increase the angle at which light is emitted, compared to an existing single image source. In the waveguide body 10, a distal end of one image source is a proximal end of the other image source. Therefore, the arrangement of two image sources can avoid the situation that there is no light exiting from the distal end of a single image source, thereby improving the picture size of the whole displayed image, increasing the field of view of the user and improving the immersive experience of the user. To ensure that light emitted by the image source group can be accurately directed to the user, the first polarized reflective film 310 has a transmission direction. When the polarization direction of light is the same as the transmission direction of the first polarized reflective film 310, the light is transmitted through the first polarized reflective film 310. When the directions are different, the light is reflected by the first polarized reflective film 310. In addition, the light reflected by the first polarized reflective film 310 is further emitted towards the second surface 102 of the waveguide body 10 by the polarized conversion assembly, until the polarization status of the light is the same as the transmission direction of the first polarized reflective film 310.

Further, by arranging image sources at both ends of the waveguide body 10, the field of view can be increased. The field of view in an up-down direction can be increased if the image sources are added at the upper and lower ends of the head mounted display. The field of view in a left-right direction can be increased if the image sources are added at the left and right ends of the head mounted display.

In one embodiment, the waveguide body 10 includes a first waveguide portion 110 and a second waveguide portion 120. The first waveguide portion 110 and the second waveguide portion 120 are butted. The first light-incident end face 103 is located at the end of the first waveguide portion 110 that is away from the second waveguide body 10. The second light-incident end face 104 is located at the end of the second waveguide portion 120 that is away from the first waveguide portion 110.

The waveguide body 10 is arranged in at least two manners. In one manner, the first waveguide portion 110 and the second waveguide portion 120 are adhered and spliced. In this case, refractive indexes of the first waveguide section 110 and the second waveguide section 120 can be the same or different. Specifically, an optical adhesive is arranged between the first waveguide portion 110 and the second waveguide portion 120, and the first waveguide portion 110 and the second waveguide portion 120 are butted together to perform calibration splicing of optical images, thereby completing the arrangement of the waveguide body 10. The first waveguide portion 110 and the second waveguide portion 120 are arranged separately, thereby facilitating processing of the optical device. The calibration splicing of optical images can also ensure that the superimposed images are not ghosting.

In the second manner, the first waveguide portion 110 and the second waveguide portion 120 are integrally formed. In this case, the first waveguide portion 110 and the second waveguide portion 120 have the same material refractive index. As a monolithic device, the waveguide body 10 formed integrally reduces the steps of image calibration and is easy to mount.

In addition, the first waveguide portion 110 and the second waveguide portion 120 can have the same structural shape. That is, the first waveguide portion 110 and the second waveguide portion 120 are symmetrically arranged with the plane of a butting position between the first waveguide portion 110 and the second waveguide portion 120 as a symmetry plane.

In one embodiment, the first waveguide portion 110 includes a first sub-surface 102a, and the second waveguide portion 120 includes a second sub-surface 102b. The first sub-surface 102a and the second sub-surface 102b form the second surface 102. An included angle is formed between the first sub-surface 102a and the second sub-surface 102b. The included angle is an obtuse angle. The first sub-surface 102a and the second sub-surface 102b form an obtuse angle between user-facing sides. Therefore, a V-shaped space can be formed, and the eyes of the user can be within the V-shaped space. Through the package of the V-shaped space, the immersive experience of the user can also be improved.

In the foregoing embodiments, an included angle between the first light-incident end face 103 and the first sub-surface 102a is an acute angle, and an included angle between the second light-incident end face 104 and the second sub-surface 102b is an acute angle. The two acute angles are of the same size, ensuring symmetrical light propagation paths and reducing ghosting. In addition, by setting the acute angle, the Incidence angle from the first image source 210 to the first sub-surface 102a and that from the second image source 220 to the second sub-surface 102b are both adjusted to reach the critical angle required for total internal reflection. In this case, a light exit surface of the first image source 210 faces the first sub-surface 102a, and a light exit surface of the second image source 220 faces the second sub-surface 102b.

Besides, the included angle between the first light-incident end face 103 and the first sub-surface 102a is an obtuse angle, and the included angle between the second light-incident end face 104 and the second sub-surface 102b is an obtuse angle. The two obtuse angles have the same size. In this case, the light exit surface of the first image source 210 faces the second surface 102, and the light exit surface of the second image source 220 faces the second surface 102.

In one embodiment, when the optical structure is applied to the AR display technology, the external ambient light is emitted to the waveguide body 10. After the light propagates through the polarized conversion assembly and the waveguide body 10, the propagation path of the light is changed, and it is difficult to image on the same surface. This can result in a phase difference, such as optical distortion. To reduce the optical distortion, the optical structure further includes a correction compensator 50 for correcting a phase difference. The correction compensator 50 is arranged on the second surface 102 of the waveguide body 10. The material of the correction compensator 50 can be the same as or different from the material of the waveguide body 10. The correction compensator 50 is configured to correct the passing light path, so that the light passes through the optical structure and is imaged on the same surface, thereby reducing the distortion.

In one embodiment, the polarized conversion assembly includes a first phase retarder 410, a holographic reflective film 420, a second phase retarder 430, and a second polarized reflective film 440. The first phase retarder 410, the holographic reflective film 420, the second phase retarder 430, and the second polarized reflective film 440 are sequentially arranged away from the waveguide body 10. The first phase retarder 410 is a quarter waveguide. The second phase retarder 430 is a quarter wave plate or a three-quarter wave plate. A retardation between the first phase retarder 410 and the second phase retarder 430 is a quarter of wavelength. The holographic reflective film 420 is a diffractive optical film layer made according to holographic principles. The relationship of entrance, reflection and transmission of light can be designed by designing a diffraction pattern of the holographic reflective film 420, so that the holographic reflective film 420 has angle selectivity. That is, the holographic reflective film 420 can reflect light at a preset angle and transmit light at other angles. It should be noted that when the holographic reflective film 420 is manufactured, object light and reference light emitted from a point light source are generally used for exposing the holographic reflective film 420. In some embodiments of the present disclosure, the holographic reflective film 420 can be integrally exposed with light having RGB three-color wavelengths. This allows the holographic reflective film 420 to reflect red light, green light and blue light in light incident at the preset angle, and the red light, the green light and the blue light reflected by the holographic reflective film 420 can be mixed to form light of various gray scales required for displaying an image. The second polarized reflective film 440 has a polarized transmission direction. Light in the same polarized transmission direction is transmitted, and light in a direction opposite to the polarized transmission direction is reflected.

In this embodiment, the propagation process of light is described in detail. The light emitted by the first image source 210 and the second image source 220 is linear polarized light. The linear polarized light has a first polarization state and a second polarization state, namely, P light and S light. The first image source 210 emits first light 211. The first light 211 has a first polarization state. The light in the first polarization state is emitted to the second surface 102 of the waveguide body 10. When the first light 211 passes through the first polarized reflective film 310, the vibration direction of the first light 211 is different from the transmission direction of the first polarized reflective film, and the first light 211 is reflected for the first time towards the surface 101 of the waveguide body 10. After the first light 211 is emitted to a first quarter wave plate, the first light is converted into circular polarized light. In this case, the first light 211 is emitted to the holographic reflective film 420 at an angle other than the preset angle, and the first light 211 is transmitted through the holographic reflective film 420. The first light 211 passes through a second quarter wave plate, and the circular polarized light is converted into linear polarized light. In this case, the polarization direction of the linear polarization state is different from the transmission direction of the second polarized reflective film 440. The first light 211 is reflected by the second polarized reflective film 440. The reflected first light 211 passes through the second quarter wave plate, the holographic reflective film 420 and the first quarter wave plate sequentially. After the first light 211 passes through the second quarter wave plate and the first quarter wave plate sequentially, the polarization status remains unchanged. In this case, the first light 211 is emitted to the first polarized reflective film 310, the polarization direction of the first light 211 is different from the transmission direction of the first polarized reflective film 310, and the first light 211 is reflected to the first surface 101 for the second time. After the first light 211 passes through the first quarter wave plate, the circular polarized light of the first light 211 in the first polarization state incident at the preset angle is emitted to the holographic reflective film 420, and the holographic reflective film 420 reflects the first light 211. After passing through the first quarter wave plate again, the first light 211 is converted into linear polarized light. In this case, the polarization status of the first light 211 is the same as the transmission direction of the first polarized reflective film 310. The first light 211 penetrates through the first polarized reflective film 310. The holographic reflective film 420 can reflect light at the preset angle and reflect light at an angle other than the preset angle. The refraction and reflection of light in the waveguide body 10 can effectively reduce the propagation space of the light and reduce the volume of the head mounted display.

In addition, the polarized conversion assembly includes a first phase retarder 410, a holographic reflective film 420 and a polarizer. The first phase retarder 410, the holographic reflective film 420 and the polarizer are sequentially arranged away from the waveguide body. Therefore, when the first light 211 is first emitted to the first surface 101, the Incidence angle on the first surface 101 is greater than or equal to the total reflection critical angle, and the first light 211 is emitted from an optically thicker medium to an optically thinner medium. The first light 211 is totally reflected, and the first light 211 is reflected to the second surface 102. The function of the polarizer is to convert external light into linear polarized light.

Similarly, the second image source 220 emits second light 221. For the propagation process of the second light 221, refer to the propagation process of the first light 211. Details are not described herein again.

Furthermore, to ensure that the light emitted from the first image source 210 and the second image source 220 is linear polarized light, polarizers can be arranged on the light exit surfaces of the first image source 210 and the second image source 220. These polarizers convert incident natural light, circular polarized light, or elliptically polarized light into linear polarized light.

This embodiment can alternatively be used in the AR display technology. In this case, external light 610 is required to enter the head mounted display. To ensure that light can smoothly enter the head mounted display, the polarized conversion assembly is further configured to transmit the second polarized light in the external light 610 to the first polarized reflection layer 310, so that the second polarized light in the external light 610 is transmitted through the waveguide body 10. The external light 610 is ambient light in an environment in which the optical waveguide device is located. That is, the head mounted display using the waveguide body 10 can transmit background light. The second polarized reflective film 440 has a polarized transmission direction. The polarized transmission direction of the second polarized reflective film 440 is the same as the vibration direction of the second polarized light. The second polarized light in the external light 610 can penetrate through the second polarized reflective film 440. Light in another polarization status is reflected and blocked outside the waveguide body 10. Light in the second polarization state passes through the second quarter wave plate, the holographic reflective film 420, and the first quarter wave plate sequentially. The polarization status of the light in the second polarization state remains unchanged. After the light in the second polarization state is emitted to the first polarized reflective film 310, the polarization direction of the second polarization state is the same as the transmission direction of the first polarized reflective film 310. Therefore, the external light 610 can be smoothly transmitted through the waveguide body 10. An integrated virtual-real display mode can be realized.

In one embodiment, the optical structure further includes an anti-reflection polarizing film 320. The anti-reflection polarizing film 320 is arranged on a side of the first polarized reflective film 310 that is away from the waveguide body 10. The anti-reflection polarizing film 320 further filters out the light in the first polarization state and ensures smooth transmission of the light in the second polarization state. In addition, there can further be light emitted to the second surface 102 in the direction of a user. Due to the presence of the light, the user can see an image on this side, and the presence of the light can affect a viewing effect of the user. The reflection of the light can also be reduced by the arrangement of the anti-reflection polarizing film 320.

In one embodiment, the first image source 210 and the second image source 220 are any one of a laser image source, an LED image source, an OLED image source, or a micro-LED image source. The image source can be a laser image source. An image displayed by the laser image source is a laser light source image, including a laser-illuminated LCD image or a projected real image projected on a diffusion film by a laser-illuminated micro projector.

The present disclosure further provides a near-eye display device. The near-eye display device includes a housing and an optical structure. The optical structure is arranged in the housing. The optical structure includes a waveguide body 10, an image source group, a first polarized reflective film 310, and a polarized conversion assembly. The image source group is arranged near the waveguide body 10 and can be spaced apart from the waveguide body 10 by a specific distance or can be in contact with the surface of the waveguide body 10. The first polarized reflective film 310 and the polarized conversion assembly are arranged on two opposite surfaces of the waveguide body 10 respectively. The first polarized reflective film 310 and the polarized conversion assembly can be independent optical devices or can be a film layer structure attached to the waveguide body 10.

The waveguide body 10 has a first surface 101 and a second surface 102 opposite to each other. The waveguide body 10 further has a first light-incident end face 103 and a second light-incident end face 104 opposite to each other. The first light-incident end face 103 is located between the first surface 101 and the second surface 102 of the waveguide body 10. The second light-incident end face 104 is located between the first surface 101 and the second surface 102 of the waveguide body 10. The first surface 101 faces an external environment, and the second surface 102 faces a user. The first surface 101 is also a flat surface.

The image source group includes a first image source 210 and a second image source 220. The first image source 210 is arranged on the first light-incident end face 103. The second image source 220 is arranged on the second light-incident end face 104. The first polarized reflective film 310 is arranged on the second surface 102 of the waveguide body 10.

The polarized conversion assembly is arranged on the first surface 101 of the waveguide body 10. The polarized conversion assembly is configured to emit light of the first image source 210 and the second image source 220 to the second surface 102 of the waveguide body 10. The optical structure can be applied to an AR display technology and a VR display technology. When the optical structure is applied to the AR display technology, light from the external environment is required to be incident on the second surface 102. For this purpose, the polarized conversion assembly can also transmit light from the outside to the waveguide body 10. The light emitted by the image source group and the light from the external environment are superimposed together.

In the technical solutions of this embodiment, compared with the existing single image source, image sources arranged at both ends of the waveguide body 10 of the near-eye display device respectively can enlarge the source of image light and increase the angle of emitting light. In the waveguide body 10, a distal end of one image source is a proximal end of the other image source. Therefore, the arrangement of two image sources can avoid the situation that there is no light exiting from the distal end of a single image source, thereby improving the picture size of the whole displayed image, increasing the field of view of the user and improving the immersive experience of the user. To ensure that light emitted by the image source group can be accurately directed to the user, the first polarized reflective film 310 has a transmission direction. When the polarization direction of light is the same as the transmission direction of the first polarized reflective film 310, the light is transmitted through the first polarized reflective film 310. When the directions are different, the light is reflected by the first polarized reflective film 310. In addition, the light reflected by the first polarized reflective film 310 is further emitted towards the second surface 102 of the waveguide body 10 by the polarized conversion assembly, until the polarization status of the light is the same as the transmission direction of the first polarized reflective film 310.

For other implementations of the near-eye display device, refer to the design of the foregoing optical structure. Details are not described herein again.

It can be seen that the present disclosure discloses an optical structure and a near-eye display device. In the optical structure, a waveguide body has a first surface and a second surface opposite to each other. The waveguide body further has a first light-incident end face and a second light-incident end face opposite to each other. The first light-incident end face is located between the first surface and the second surface of the waveguide body. The second light-incident end face is located between the first surface and the second surface of the waveguide body. An image source group includes a first image source and a second image source. The first image source is arranged on the first light-incident end face. The second image source is arranged on the second light-incident end face. A first polarized reflective film is arranged on the second surface of the waveguide body. A polarized conversion assembly is arranged on the first surface of the waveguide body. The polarized conversion assembly is configured to emit the light from the first image source and the second image source to the second surface of the waveguide body. The present disclosure can improve the picture size of a displayed image, improve the field of view of a user and ensure the immersive experience of the user.

In conclusion, in a first aspect, embodiments of the present disclosure provide an optical structure. The optical structure includes: a waveguide body, an image source group, a first polarized reflective film, and a polarized conversion assembly.

The waveguide body has a first surface and a second surface opposite to each other. The waveguide body further has a first light-incident end face and a second light-incident end face opposite to each other. The first light-incident end face is located between the first surface and the second surface of the waveguide body. The second light-incident end face is located between the first surface and the second surface of the waveguide body.

The image source group includes a first image source and a second image source. The first image source is arranged on the first light-incident end face. The second image source is arranged on the second light-incident end face.

The first polarized reflective film is arranged on the second surface of the waveguide body.

The polarized conversion assembly is arranged on the first surface of the waveguide body.

The polarized conversion assembly is configured to emit light of the first image source and the second image source to the second surface of the waveguide body.

In a second aspect, based on the optical structure described in the first aspect, the waveguide body includes a first waveguide portion and a second waveguide portion. The first waveguide portion and the second waveguide portion are butted. The first light-incident end face is located at the end of the first waveguide portion that is away from the second waveguide body. The second light-incident end face is located at the end of the second waveguide portion that is away from the first waveguide portion.

In a third aspect, based on the optical structure described in the second aspect, the first waveguide portion and the second waveguide portion are adhered and spliced.

Alternatively, the first waveguide portion and the second waveguide portion are integrally formed.

In a fourth aspect, based on the optical structure described in the second aspect, the first waveguide portion includes a first sub-surface, and the second waveguide portion includes a second sub-surface. The first sub-surface and the second sub-surface form the second surface. An included angle is formed between the first sub-surface and the second sub-surface. The included angle is an obtuse angle.

In a fifth aspect, based on the optical structure described in the fourth aspect, an included angle between the first light-incident end face and the first sub-surface is an acute angle, and an included angle between the second light-incident end face and the second sub-surface is an acute angle.

In a sixth aspect, based on the optical structure described in any one of the first to fifth aspects, the optical structure further includes a correction compensator for correcting a phase difference. The correction compensator is arranged on the second surface of the waveguide body.

In a seventh aspect, based on the optical structure described in the sixth aspect, the polarized conversion assembly includes a first phase retarder, a holographic reflective film, a second phase retarder, and a second polarized reflective film. The first phase retarder, the holographic reflective film, the second phase retarder, and the second polarized reflective film are sequentially arranged away from the waveguide body.

Alternatively, the polarized conversion assembly includes a first phase retarder, a holographic reflective film and a polarizer. The first phase retarder, the holographic reflective film and the polarizer are sequentially arranged away from the waveguide body.

In an eighth aspect, based on the optical structure described in the seventh aspect, the optical structure further includes an anti-reflection polarizing film. The anti-reflection polarizing film is arranged on a side of the first polarized reflective film away from the waveguide body.

In a ninth aspect, based on the optical structure described in any one of the first to fifth aspects, the first image source and the second image source are any one of a laser image source, an LED image source, an OLED image source, or a micro-LED image source.

In a tenth aspect, embodiments of the present disclosure provide a near-eye display device. The near-eye display device includes a housing and the optical structure as described in any one of the first to ninth aspects. The optical structure is arranged in the housing.

Various embodiments are described in this specification in a progressive manner. Each embodiment focuses on differences from the other embodiments. For same or similar parts of the various embodiments, refer to these embodiments. The apparatus disclosed in the embodiments corresponds to the method disclosed in the embodiments, and therefore, is described simply. For related parts, refer to the part of the descriptions of the method embodiment. The foregoing description of the disclosed embodiments enables a person skilled in the art to practice or use the present disclosure. Various modifications made to these embodiments are obvious to a person skilled in the art and the general principles defined herein can be implemented in other embodiments without departing from the spirit or scope of the present disclosure. Therefore, the present disclosure is not limited to the embodiments shown herein but is intended to conform to the widest scope consistent with the principles and novel features disclosed herein.

1. An optical waveguide device, comprising:
an optical waveguide dielectric body, a first polarized reflection layer, and an optical structure layer;
the optical waveguide dielectric body comprises a first surface and a second surface opposite to each other, the first polarized reflection layer is arranged on the first surface, and the optical structure layer is arranged on the second surface;
the optical waveguide dielectric body is configured to propagate light, which includes a first polarized light;
the first polarized reflection layer is configured to reflect the first polarized light and transmit a second polarized light, where the polarization direction of the second polarized light is perpendicular to that of the first polarized light;
the optical structure layer is configured to convert the first polarized light, incident at a preset angle, into the second polarized light, and to reflect the second polarized light back to the first polarized reflection layer, as well as to reflect the first polarized light, incident at other angles back to the first polarized reflection layer.

2. The optical waveguide device as set forth in claim 1, wherein a first included angle is formed between planes on which the first surface and the second surface are located, and the first included angle is an acute angle, to change an incidence angle of the first polarized light that is re-propagated to the first polarized reflection layer or the optical structure layer.

3. The optical waveguide device as set forth in claim 1, wherein the optical structure layer is further configured to transmit the second polarized light from external light to the first polarized reflection layer, so that the second polarized light from the external light is transmitted through the optical waveguide device.

4. The optical waveguide device as set forth in claim 3, further comprising a light transmission control layer, wherein the light transmission control layer is arranged on the side of the optical structure layer that is away from the optical waveguide dielectric body; and
in the first state, the light transmission control layer transmits the external light, to allow the external light to be incident on the optical structure layer; and in the second state, the light transmission control layer blocks the external light, preventing the external light from being incident on the optical structure layer.

5. The optical waveguide device as set forth in claim 3, wherein the optical structure layer comprises a first phase retarder layer, a reflective holographic optical element, a second phase retarder layer, and a second polarized reflection layer;
the first phase retarder layer, the reflective holographic optical element, the second phase retarder layer, and the second polarized reflection layer are sequentially arranged on the second surface;
the first phase retarder layer and the second phase retarder layer are both configured to delay the phase of the light; the polarization state of the first polarized light remains unchanged after passing through the first phase retarder layer and the second phase retarder layer, and the first polarized light is converted into the second polarized light by the first phase retarder layer or the second phase retarder layer after an even number of passes;
the reflective holographic optical element is configured to reflect light incident at the preset angle and to transmit light incident at other angles; and
the second polarized reflection layer is configured to reflect the first polarized light and transmit the second polarized light.

6. The optical waveguide device as set forth in claim 5, wherein the first phase retarder layer comprises a ¼ wavelength retardation layer; and
the second phase retarder layer comprises a ¾ wavelength retardation layer; or
the second phase retarder layer comprises a ¼ wavelength retardation layer, but the second phase retarder layer has an opposite retardation direction compared to the first phase retarder layer.

7. The optical waveguide device as set forth in claim 5, wherein the reflective holographic optical element only reflects red, green, and blue light from incident light at the preset angle.

8. The optical waveguide device as set forth in claim 7, wherein the reflective holographic optical element comprises a plurality of multiple reflecting regions arranged in an array; and
each reflecting region comprises a first reflecting sub-region, a second reflecting sub-region, and a third reflecting sub-region, the first reflecting sub-region is configured to reflect the red light from the light, the second reflecting sub-region is configured to reflect the green light from the light, and the third reflecting sub-region is configured to reflect the blue light from the light.

9. The optical waveguide device as set forth in claim 2, further comprising an optical correction body, wherein
the optical correction body is arranged on the side of the first polarized reflection layer or the optical structure layer, which is away from the optical waveguide dielectric body, and the optical correction body is configured to correct an exit direction of at least part of the second polarized light that exits from the first polarized reflection layer.

10. The optical waveguide device as set forth in claim 9, wherein the optical correction body and the optical waveguide dielectric body have a same refractive index;
the optical correction body comprises a third surface and a fourth surface, a second included angle is formed between the planes on which the third surface and the fourth surface are located, and the second included angle is equal to the first included angle; and
the third surface is parallel to the first surface, and the fourth surface is parallel to the second surface.

11. The optical waveguide device as set forth in claim 1, further comprising a polarization absorption layer, wherein
the polarization absorption layer is arranged on a side of the first polarized reflection layer, which is away from the optical waveguide dielectric body, and/or, the polarization absorption layer is arranged on a side of the optical structure layer, also away from the optical waveguide dielectric body; and
the polarization absorption layer is configured to absorb the first polarized light and transmit the second polarized light.

12. The optical waveguide device as set forth in claim 1, wherein the exit direction of the second polarized light exiting from the first polarized reflection layer is perpendicular to the second surface, or the exit direction of the second polarized light exiting from the first polarized reflection layer is perpendicular to the first surface.

13. A display apparatus, comprising a micro image source and the optical waveguide device according to claim 1, wherein the micro image source is configured to emit light, which is required for image display to the optical waveguide device, and the light includes the first polarized light.

14. The display apparatus as set forth in claim 13, wherein the micro image source comprises a laser image source, an LED image source, an OLED image source, or a micro-LED image source.

15. A display device, comprising the display apparatus according to claim 13.
